(19) United States
(12) Patent Application Publication
(10) Pub. No.: US 2014/0339078 A1
(43) Pub. Date: Nov. 20, 2014

(54) GLUCOSE SENSOR INCLUDING NOBLE METAL-GRAPHENE COMPOSITES

(71) Applicant: KOREA INSTITUTE OF GEOSCIENCE AND MINERAL RESOURCES, Yuseong-gu (KR)

(72) Inventors: Hee Dong JANG, Yuseong-gu (KR); Han Kwon CHANG, Seo-gu (KR); Sun Kyung KIM, Seo-gu (KR); Ki Min ROH, Yuseong-gu (KR)

(73) Assignee: KOREA INSTITUTE OF GEOSCIENCE AND MINERAL RESOURCES, Yuseong-gu (KR)

(21) Appl. No.: 14/028,678

(22) Filed: Sep. 17, 2013

(30) Foreign Application Priority Data
May 20, 2013 (KR) 10-2013-0056768

(51) Int. Cl. G01N 27/327

(52) U.S. Cl. CPC G01N 27/3271
USPC 204/403.14; 204/403.01; 264/5; 264/9; 252/503

(57) ABSTRACT

Provided is a glucose sensor. The glucose sensor according to the present invention includes noble metal-graphene composites, and has high sensitivity and significantly excellent current flow as compared to titanium dioxide-graphene composites. In addition, the noble metal-graphene composite manufactured by aerosol spray pyrolysis serves as an improved glucose sensor having desirable sensitivity, stability, reproducibility, and selectivity.

### CROSS-REFERENCE TO RELATED APPLICATIONS

This application claims priority under 35 U.S.C. §119 to Korean Patent Application No. 10-2013-0056768, filed on May 20, 2013, in the Korean Intellectual Property Office, the disclosure of which is incorporated herein by reference in its entirety.

### TECHNICAL FIELD

The following disclosure relates to a method of manufacturing noble metal-graphene composites, noble metal-graphene composites manufactured by the method, and a glucose sensor including the composites.

### BACKGROUND

Glucose is a diverse nutritional source of most organisms, and plays basic roles such as energy supply, carbon storage, biosynthesis, and the like, such that research into a technology of developing devices for measuring glucose has been actively conducted. The reason that a glucose biosensor among the biosensors based on an enzyme is receiving attention is because it is important to measure a concentration of glucose in blood for treating and controlling diabetes. Most of the glucose biosensors are based on a glucose oxidase (GOD), the glucose functions as a catalyst in a reaction. A principle of the general glucose biosensor is based on detection of a hydrogen ion based on the following equation.

Glucose+GOD-FAD-->gluconolactone+GOD-FADH2

FADH₂<-->FAD+2H++2e−

The glucose is used as a substance of the GOD to generate a catalytic reaction based on the enzyme and to decrease a concentration of GOD-FAD on a surface of an electrode. Here, a material coupled with the GOD generates a rapid electron transport reaction in the electrode.

Graphene (GR) is a single atom sheet of densely condensed carbon in a two-dimensional hexagonal sheet. The single structure of the graphene is characterized by high specific surface, high thermal conductivity, excellent mechanical strength, effective biocompatibility, rapid electron transport, or the like, and therefore, the graphene has been favorably used in fields such as nanocomposites, solar cells, and electrochemical sensors.

A number of materials such as metal oxides, semiconductors, and noble metals have been used for covering graphene composites. For example, Korean Patent No. KR1107506 discloses that titanium dioxide nanoparticles have been continuously spotlighted due to a large specific surface, uniformity, and excellent biocompatibility thereof. The noble metals may provide biocompatibility or stability which prevents a phenomenon such as metal dissolution during a reduction reaction. In addition, the biosensor based on several metals may provide effective selectivity and sensibility in oxidation of the glucose. Therefore, it is expected that a noble metal composite and a graphene composite become a functional material in the electrochemical field.

### RELATED ART DOCUMENT

### Patent Document

### (Patent Document 1) KR 1107506 B1

### (Patent Document 2) KR 2012-0121716 A

### SUMMARY

An embodiment of the present invention is directed to providing an improved glucose biosensor based on noble metal-graphene composites.

In one general aspect, a glucose sensor includes noble metal-graphene composites as an electric charge transport.

The glucose sensor may further include an electrode to which a glucose oxidase or a glucose dehydrogenase and the noble metal-graphene composites are fixed, and the noble metal may be platinum (Pt), gold (Au), or palladium (Pd).

The composite may be manufactured by heat-treating a precursor powder of a graphene oxide-noble metal obtained by droplet spraying a dispersion solution containing the graphene oxide and the noble metal and drying the sprayed droplet.

More specifically, the precursor powder may be manufactured by spraying the dispersion solution by a supersonic wave spray and moving the sprayed droplet to a drying furnace including an inert gas.

In addition, the composite may be manufactured by heat-treating the precursor powder of the graphene oxide-noble metal under the inert gas atmosphere at 700 to 900□.

Other features and aspects will be apparent from the following detailed description, the drawings, and the claims.

### BRIEF DESCRIPTION OF THE DRAWINGS

FIG. 1 is a view showing raman spectra of a graphite and a graphene oxide;

FIG. 2 is a view showing a diagram in which a noble metal-graphene (GR) composite is formed from a droplet by an aerosol spray pyrolysis of a noble metal precursor and a graphene oxide;

FIGS. 3A, 3B and 3C are views showing FE-SEM (field emission scanning electron microscope) and TEM (transmission electron microscope) photographs of the noble metal-GR composite;

FIG. 4 is a view showing an X-ray diffraction pattern of the noble metal-GR composite; and

FIG. 5 is a view showing a cyclic voltammogram of a glucose sensor manufactured by the noble metal-GR composite; and

FIG. 6 is a view showing the sensitivity of platinum-graphene and gold-graphene. The platinum-graphene and gold-graphene composites had sensitivity of 62 and 15 μA/mM·cm², respectively.

### DETAILED DESCRIPTION OF EMBODIMENTS

Hereinafter, a glucose sensor according to the present invention will be described in detail with reference to the accompanying drawings.

The glucose sensor according to the present invention may include noble metal-graphene composites.

The glucose sensor may generally have two electrodes structure including an electrode to which a glucose oxidase or a glucose dehydrogenase and the noble metal-graphene composites are fixed, wherein the noble metal may be platinum (Pt), gold (Au), or palladium (Pd).

In addition, a weight ratio (noble metal/graphene) of the noble metal to the graphene may be 0.05 to 0.20, but the present invention is not limited thereto.

The composite may be manufactured by heat-treating a precursor powder of the graphene oxide-noble metal obtained by droplet spraying a dispersion solution containing the graphene oxide and the noble metal and drying the sprayed droplet.

The precursor powder may be manufactured by spraying the dispersion solution by a supersonic wave spray and moving the sprayed droplet to a drying furnace containing an inert gas.

The composite may be manufactured by heat-treating the precursor powder of the graphene oxide-noble metal under the inert gas atmosphere at 700 to 900□.

In addition, in a working electrode a predetermined voltage is applied to a material to be measured in order to measure a reaction current between the glucose and the enzyme, wherein a reference electrode provides a reference electric potential for measuring the reaction current between the glucose and the enzyme. In this case, a coating layer included in the working electrode preferably contains the enzyme in 100 to 300 units with respect to the noble metal-graphene composite of 1 mg.

Hereinafter, the noble metal-graphene composites included in the glucose sensor according to the present invention will be described in detail.

The noble metal-graphene composite may be manufactured by heat-treating the precursor powder of the graphene oxide-noble metal obtained by spraying the dispersion solution containing the graphene oxide and the noble metal in the droplet state and drying the sprayed droplet.

The noble metal-graphene composite is manufactured by the heat-treatment of the precursor powder obtained by the droplet spraying and drying processes, such that the composite is a secondary particle in which a noble metal particle and a graphene particle are aggregated and has a secondary particle structure in which primary particles of the noble metal are aggregated and then the entire or a portion of surface of a porous aggregate of the noble metal is covered with the graphene by a weight ratio of the noble metal to the graphene oxide contained in the dispersion solution, and conditions of spraying and drying the droplet and heat-treating the precursor powder.

The dispersion solution may contain the graphene oxide of 5 to 200 parts by weight based on 100 parts by weight of the noble metal, and more specifically, may contain the graphene oxide of 5 to 20 parts by weight based on 100 parts by weight of the noble metal. The degree in which the surface of the noble metal aggregate is covered with the graphene may be controlled by the weight ratio of the noble metal to the graphene oxide contained in the dispersion solution. Since the dispersion solution contains the graphene oxide of 5 to 20 parts by weight based on 100 parts by weight of the noble metal, the composite having a structure in which the surface of the graphene is partially covered with the noble metal may be manufactured, and in the case in which the dispersion solution contains the graphene oxide over the above range, the composite having a structure in which the surface of the graphene is entirely covered with the noble metal may be manufactured. Any material into which the noble metal and the graphene oxide are smoothly dispersed may be used for the dispersion solution, and for example, the dispersion solution may be an aqueous dispersion solution. The precursor powder obtained by supersonic wave spraying and drying the dispersion solution may be reduction heat-treated, wherein the reduction heat-treatment is preferably performed under the inert gas atmosphere at a temperature of 700 to 900□ for 20 to 60 minutes.

Hereinafter, examples of the present invention will be described in detail. The following examples are described for explaining the present invention by way of example, and the scope of the present invention is not limited thereto.

### Example 1

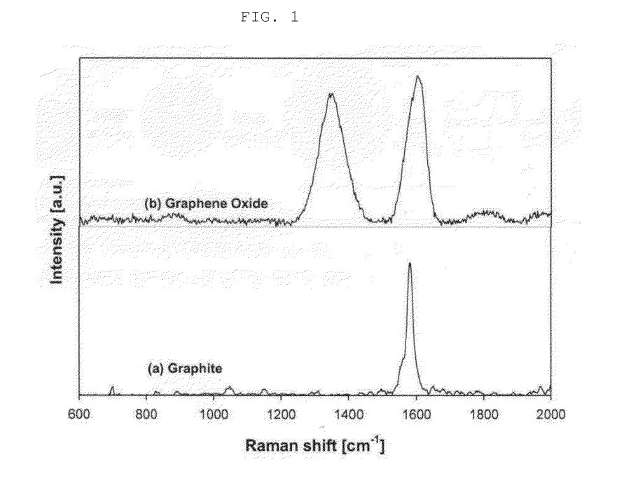

FIG. 1 shows a Raman spectra of a graphite and a graphene oxide (Lambda Ray, LSI Dimension P1, 532 nm laser excitation). In the graphite, a clear peak was shown at 1579 cm-1 known as a G band, which corresponded to a primary dispersion mode of a carbon. In the graphene oxide, the G band was shown at 1600 cm-1, and a D band was shown at 1337 cm-1. The graphene oxide had the G band wider than that of the graphite, which is caused by an extensive oxidation reaction. Therefore, it could be confirmed that the graphene oxide was synthesized from the graphite (Alfa Aesar, 99.9%) by a modified Hummer's method. The modified Hummer's method is specifically described in Cote, L. J., Kim, F., Huang, J. J. Am. Chem. Soc. 2009, 131, 1043-1049.

### Example 2

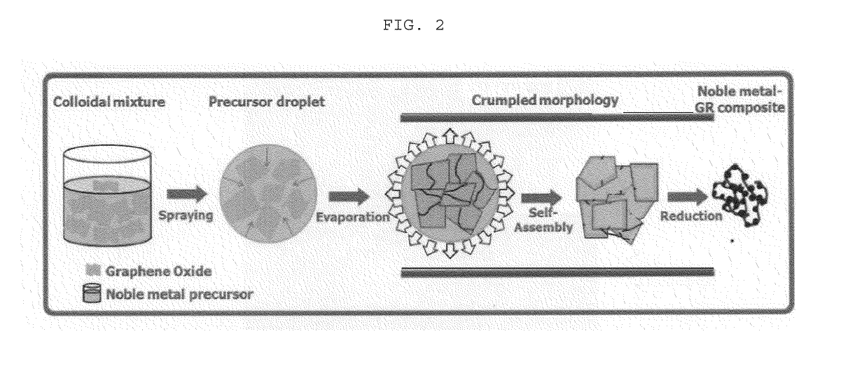

A process for synthesizing the composite of the noble metal and the graphene oxide is as follows (FIG. 2). A colloidal mixture solution having a prepared graphene oxide colloid and the noble metal precursor (H2PtCl6.6H2O, HAuCl4.3H2O or PdCl2) was prepared. In this case, the mixture solution was prepared so that the weight ratio of the noble metal to the graphene (the noble metal/the graphene) is 0.2 in a state in which the graphene oxide in the colloidal mixture has a concentration of 0.5 wt %. The noble metal-graphene oxide precursor was sprayed by using an ultrasonic atomizer. The sprayed dispersion solution was moved to a heating furnace by using an argon gas of 1.0 l/min. The heating furnace had a length of 410 mm and a diameter of 25.4 mm, and was operated at 800□. In this case, a reduction reaction of the metal precursor and the graphene oxide was generated together in the heating furnace. As described above, the noble metal-graphene composite was easily synthesized by using an aerosol spray pyrolysis method without using any reducing agent. The manufactured noble metal-graphene composites were collected by using a Teflon filter.

### Example 3

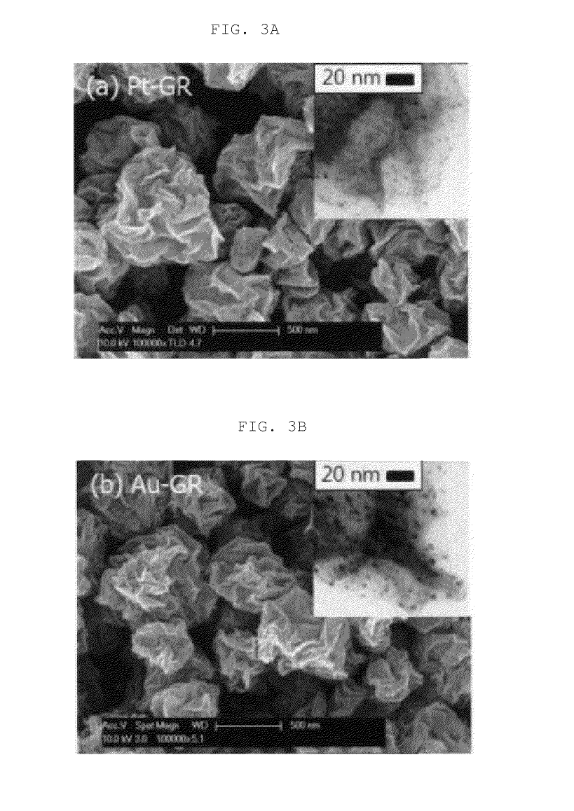

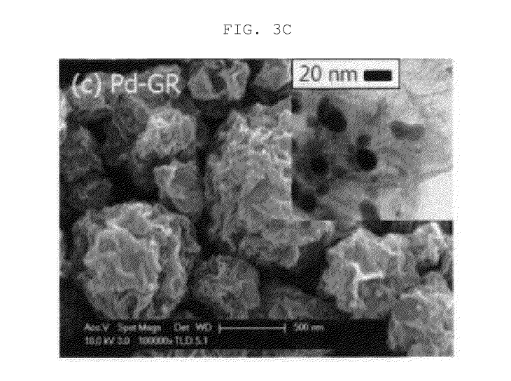

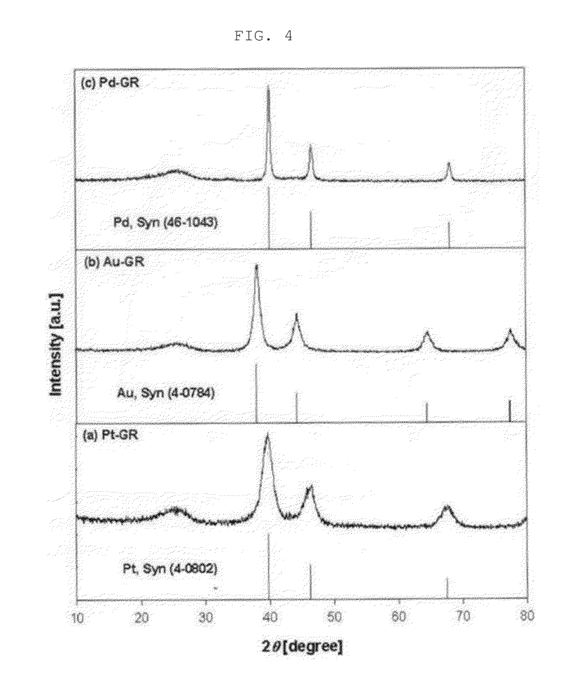

A shape of the noble metal-graphene composite was analyzed by using a field emission scanning electron microscope (FE-SEM) (See FEI, Sirion; FIGS. 3A, 3B and 3C). As a result, the noble metal-graphene composites generally had a shape of a crumpled paper ball, and had an average size of 1 μm. It was confirmed by TEM (transmission electron microscope) analysis that the noble metal nanoparticles were deposited on the surface of the crumpled graphene (Philips, CM12).

### Example 4

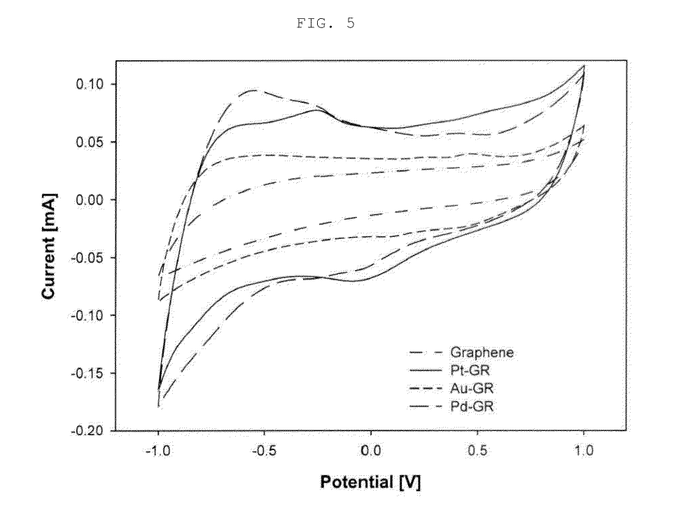

A diffraction pattern of the noble metal-graphene composite was analyzed by using an X-ray Diffraction Extensible Resource Descriptor (XRD) (Rigaku, RTP 300 RC). A degree of crystallinity of the particle manufactured as described above was analyzed (See FIG. 4).

### Example 5

A noble metal-graphene electrode was manufactured as follows. The noble metal-graphene composite of 1 mg was dispersed into a 10 mg/ml of glucose oxidase (GOD) solution (Sigma Aldrich, Aspergillus niger, 200 units/mg) of 1 ml. The noble metal-graphene/glucose oxidase colloid was stored at 4 □ for 24 hours, and was centrifuged at 10,000 rpm for hour for completely fixing the glucose oxidase. The obtained precipitate was re-dispersed into a 0.01M PBS solution of 1 ml (Fluka, pH 7). In order to perform a cyclic voltammetry measurement, the noble metal-graphene/glucose oxidase colloid of 5 μl was dropped on a glass carbon electrode and left until it was dried in room temperature. Then, a Nafion solution (Sigma Aldrich) in 0.05 wt % of 10 μl was sprayed on the electrode, and the noble metal-graphene composites were fixed to the modified glass electrode. D-(+)-glucose (Sigma Aldrich, 0.8 mM) was used for a reaction of a glucose biosensor. Then, electrochemical properties of the glucose biosensor using the cyclic voltammetry were measured by using equipment (Bio-Logics, model VSP). A glass carbon electrode (CH Inc., 3 mm diameter) was used as a working electrode, an Ag/AgCl electrode (BAS Inc.) was used as a reference electrode, and a platinum foil (Bas Inc.) was used as a comparative electrode. A peak current refers to an electric potential having a range from −1.0 V up to 1.0 V at a scanning rate of 50 mV/s.

Results obtained by the FE-SEM (field emission scanning electron microscope) and the TEM (transmission electron microscope) analysis were shown in FIGS. 3A, 3B and 3C. It could be confirmed by FIGS. 3A, 3B and 3C that in platinum (Pt) of FIG. 3A, the nanoparticles having a diameter of 5 nm or smaller were uniformly applied on a graphene sheet, in gold (Au) of FIG. 3B, the nanoparticles having a diameter of 5 nm were distributed on the graphene sheet in a range larger than that of the platinum (Pt), and in Palladium (Pd) of FIG. 3C, the nanoparticles having 5 to 10 nm were positioned on the graphene sheet.

As a result obtained by analyzing each crystallinity of the noble metal-graphene composites through the XRD analysis, a peak by the noble metal was shown. Each crystalline size calculated by Scherrer formula was in a sequence of 4.3, 8.5, and 23.2 nm. Therefore, it could be confirmed that the noble metal nanoparticles were successfully crystallized at 800 □ in the noble metal concentration by the aerosol spray pyrolysis method.

FIG. 5 shows the cyclic voltammogram results of the glucose biosensor manufactured by using three noble metal-graphene composites. In this case, the weight ratio of the noble metal to the graphene was 0.2. However, the electrochemical reduction peak in the platinum (Pt)-graphene composite was shown at −0.07 and −0.25 V. It is indicated that performance of the biosensor was significantly affected by a used metal, size and distribution of a nanoparticle. In particular, it could be confirmed that the uniformly distributed noble metal nanoparticles had significantly high electrochemical activity.

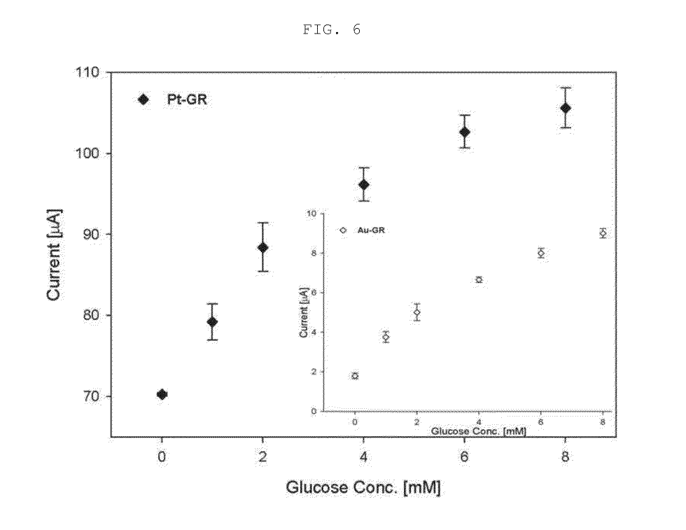

The platinum-graphene, gold-graphene, palladium-graphene composites had sensitivity of 62, 15, and 17 μA/mM·cm², respectively. (see sensitivity of platinum and gold shown in FIG. 6) As compared to the sensitivity measurement value, that is, 6.2 μA/mM·cm², of the TiO₂-graphene according to the related art (fang et al., Biosens Bioelectron 2012, 38, 184-188), it could be confirmed that the noble metal-graphene composite according to the present invention had remarkably excellent performance.

As set forth above, the glucose sensor according to the present invention includes the composites obtained by spraying the dispersion solution containing the graphene oxide and the noble metal in the droplet state, drying and heat-treating the sprayed droplet in the electrode thereof, thereby having the significantly excellent current flow, while being sensitive to the change degree in the current with respect to the change in the electric potential, and having high sensitivity and excellent low capacitance.

What is claimed is:

1. A glucose sensor comprising noble metal-graphene composites.

2. The glucose sensor of claim 1, further comprising an electrode to which a glucose oxidase or a glucose dehydrogenase and the noble metal-graphene composites are fixed.

3. The glucose sensor of claim 1, wherein the noble metal is platinum (Pt), gold (Au), or palladium (Pd).

4. The glucose sensor of claim 3, wherein a weight ratio (noble metal/graphene) of the noble metal to the graphene is 0.05 to 0.20.

5. The glucose sensor of claim 1, wherein the composite is manufactured by heat-treating a precursor powder of a graphene oxide-noble metal obtained by droplet spraying a dispersion solution containing the graphene oxide and the noble metal and drying the sprayed droplet.

6. The glucose sensor of claim 5, wherein the precursor powder is manufactured by spraying the dispersion solution by an ultrasonic atomizer and moving the sprayed droplet to a drying furnace containing an inert gas.

7. The glucose sensor of claim 5, wherein the composite is manufactured by heat-treating the precursor powder of the graphene oxide-noble metal under the inert gas atmosphere at 700 to 900° C.
